(19) United States
(12) Patent Application Publication
(10) Pub. No.: US 2007/0278332 A1
(43) Pub. Date: Dec. 6, 2007

(54) Milling tooth for rotary mulchers

(75) Inventor: Gerry Howe, Lower Millstream (CA)

Correspondence Address: G. RONALD BELL & ASSOCIATES, P.O. BOX 2450, POSTAL STATION D, OTTAWA, ON, KIP5W6, CA

(73) Assignee: Torrent Technical Incorporated, Sussex (CA)

(21) Appl. No.: 11/798,691

(22) Filed: May 16, 2007

(30) Foreign Application Priority Data
May 16, 2006 (CA) 2547096

(51) Int. Cl. B02C 25/00

(52) U.S. Cl. 241/30; 241/291

(57) ABSTRACT

The present invention relates to a milling tooth and method of using the same, having a shank, a circular flange member disposed on an end of the shank, the flange member opposite a side connected to the shank, the flange member having a predetermined dimension, a surface of the flange member being concave. The milling teeth are used in particular on rotary mulchers and have a direct impact on reducing the cost of brush cutting operations. Conventional designs of milling teeth often lead to the mulching head becoming clogged by debris resulting in an inconsistency in the quality of the end product at cost.

### CROSS REFERENCE TO RELATED APPLICATION

This application claims benefit from the priority of Canadian application Serial Number 2,547,096 titled “Milling tooth For Rotary Mulchers” filed on May 16, 2006 whose inventor is Gerry Howe.

### FIELD OF THE INVENTION

The present invention generally relates to brush-cutting machines, and in particular to milling teeth for use in such brush-cutting machines.

### BACKGROUND OF THE INVENTION

Rotary mulchers have a cutting drum to which are affixed a number of tool holders and cutting tools. The drum is fixed to driven shaft to which power is transmitted via a belt drive. The belt drive pulley may be powered hydraulically, from a PTO input to a gear-driven speed increaser or directly from an engine crankshaft. Rotational torque is countered by a cutter frame that is configured to withstand axial and radial loading but capable of being raised and lowered to engage the work. These rotary mulchers may be attached to purpose built vehicles, to large farm/industrial tractors or to large excavators.

Specific applications of mulching technology include: Reforestation; Forestry maintenance; Seismic line clearing; Drill site access roads; Oil lease clearing; Land reclamation; Compost turning; Right of way clearing; Construction site preparation; Clearing of dozer debris lines; Highway median and setback maintenance; Intersection; line-of-sight maintenance; Pipeline development and maintenance; Transmission line development, maintenance; Fire road & break construction; Municipal hiking/biking trail construction & maintenance; or Asphalt and seal-coat repairs.

The mechanical efficiency and life cycle of the aforesaid cutting tools, in particular those used on rotary mulchers have a direct impact on the efficiency and cost of brush cutting operations. In addition and in accordance with the aforesaid disadvantages, conventional designs of the milling teeth often lead to the mulching head becoming clogged by debris resulting in, for example an inconsistency in the quality of the end product and as a consequence excessive overuse of energy needed to run those mechanical operations.

In order to overcome the disadvantages of the prior art, the present invention provides a milling tooth and a method thereof for effecting an efficient and economical way in which to comminute target work thereof.

### SUMMARY OF THE INVENTION

It is an object of the present invention to provide a milling tooth that addresses the limitations of the prior art.

An aspect of the present invention provides for a milling tooth having a shank, a flange member disposed on an end of the shank, the flange member opposite a side connected to the shank.

In a preferred embodiment the present invention provides a flange member having a predetermined dimension.

In a further preferred embodiment the present invention provides the flange member having a concave a surface of a dimension in the range of in the range of from about 1.25 inches to about 1.437 inches, the concave surface defining an angled circumference directed away therefrom to an intermediate section of the flange member.

In a preferred embodiment the present invention provides for a surface of said intermediate section dimensioned for being substantially angled away from said circumference for removing debris therefrom. Preferably the intermediate surface section is substantially parallel to said shank.

A preferred embodiment of the present invention provides for the milling tooth to be forged from a durable strong material, preferably steel and hardened to a temperature of 55° C.

In a further aspect the present invention provides for a milling tooth for a comminution machine comprising: a shank for attachment to a drum of a mulching machine, a flange member disposed on an end of the shank, said flange member opposite a side connected to the shank, said flange member having a predetermined dimension for comminuting work thereof.

In an even further aspect of the present invention there is provided a method for comminuting work comprising the steps of: attaching a shank of a milling tooth to a drum of a mulching head of a comminution machine, rotating said drum, and directing a flange member disposed on an end of said shank at said work for comminution thereof, said flange member having a predetermined dimension for comminuting said work and removing debris therefrom. Accordingly, the method of the present invention provides a product of the work in an efficient and economical manner for the end-user thereof. In particular, the present invention provides a milling tooth for association with brush-cutting machines used in a wide variety of industrial settings providing economic use of the present invention to both the end-user and the general public at large.

These and other features of the invention will become more apparent from the following description in which reference is made to the appended drawings wherein:

### BRIEF DESCRIPTION OF THE DRAWINGS

FIG. 1 is a cross-sectional view of a milling tooth according to an embodiment of the present invention;

FIG. 2 is a plan view of the concave surface of the milling tooth shown in FIG. 1;

FIG. 3 is a cross-sectional view of a milling tooth according to another embodiment of the present invention; and

FIG. 4 is a plan view of the concave surface of the milling tooth shown in FIG. 3.

### DETAILED DESCRIPTION OF THE INVENTION

Although other applications may be envisioned for rotary mulchers and the cutting tools thereof, the application of the present invention is particularly advantageous for mechanical efficiency and increased life cycle of milling teeth in particular those used on rotary mulchers that have a direct impact on the cost of brush cutting operations. In addition and in accordance with the aforesaid disadvantages, conventional designs of the milling teeth often lead to the mulching head becoming clogged by debris resulting in, for example an inconsistency in the quality of the end product.

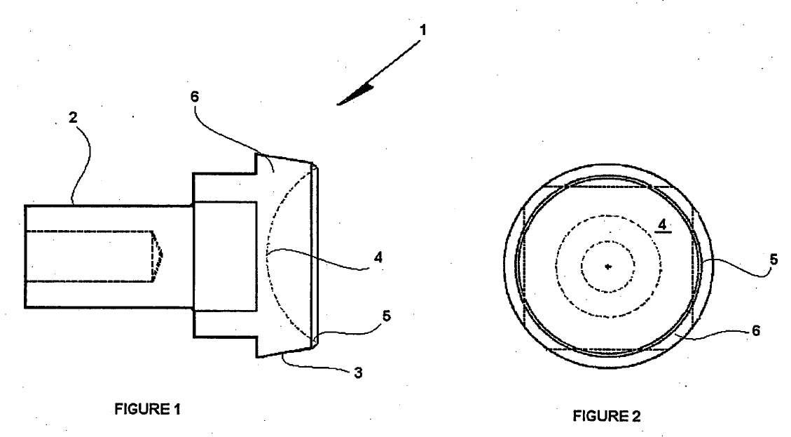

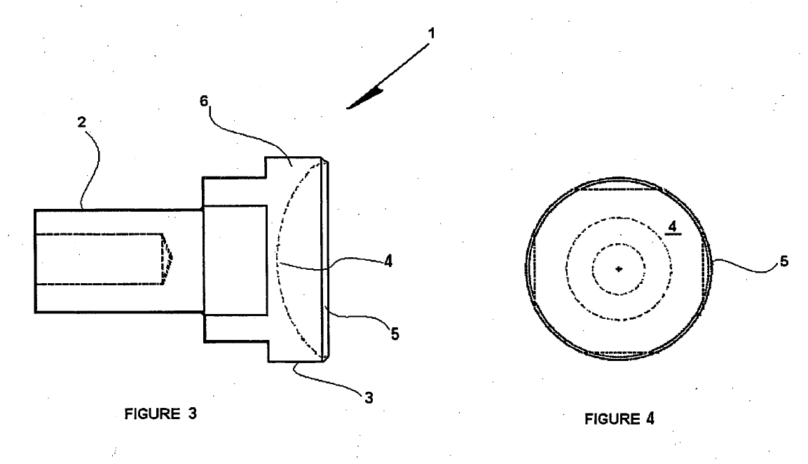

FIG. 1 shows a milling tooth (1) according to the present invention. The milling tooth (1) comprises a shank (2) and a circular flange member (3). The shank (2) is dimensioned for attachment to a rotating drum of a comminution machine (not shown). The flange member (3) is disposed on an end of the shank (2). The surface (4) of the flange member opposite the side connected to the shank (2) is concave. In a preferred embodiment the radius of the concave is between 1.25 and 1.437 inches. The concave surface (4) of the milling tooth allows for wood chips with consistent quality to be produced and limits the possibility of the cutting head becoming clogged. In a preferred embodiment the radius of the concave is between 1.25 and 1.437 inches. In addition, the use of the milling teeth (1) of the present invention reduces the horsepower requirement of the comminution machine, thus providing better fuel efficiency. The circumference (5) of the concave surface (4) of the circular flange member (3) is angled away from the concave portion to allow the debris to be shuttled away from the milling tooth (1). As shown in FIGS. 1 and 2, the surface of the intermediate section (6) of the flange member (3) that connects the concave surface (4) to the section which receives the shank (2) can also be angled away from the centre of the milling tooth (1) to aid in the removal of debris. Alternatively, the surface of the intermediate section (6) can also be substantially parallel to the shank (2)(FIGS. 3 and 4). The milling tooth (1) of the present invention can be forged using conventional methods, however steel hardened to 55° C. is preferred to provide optimum strength and durability.

### INDUSTRIAL APPLICABILITY

The work to be effected by the present invention includes but is not limited to specific applications of mulching technology: Reforestation; Forestry maintenance; Seismic line clearing; Drill site access roads; Oil lease clearing; Land reclamation; Compost turning; Right of way clearing; Construction site preparation; Clearing of dozer debris lines; Highway median and setback maintenance; Intersection; line-of-sight maintenance; Pipeline development and maintenance; Transmission line development, maintenance; Fire road & break construction; Municipal hiking/biking trail construction & maintenance; or Asphalt and seal-coat repairs.

1. A milling tooth comprising: a shank, a flange member disposed on an end of the shank, said flange member opposite a side connected to the shank, said flange member having a predetermined dimension.

2. A milling tooth according to claim 1, wherein said flange member is circular.

3. A milling tooth according to claim 1, wherein a surface of the flange member is concave.

4. A milling tooth according to claim 1, wherein the concave surface defines an angled circumference directed away therefrom to an intermediate section of the flange member.

5. A milling tooth according to claim 4, wherein a surface of said intermediate section is dimensioned for being substantially angled away from said circumference.

6. A milling tooth according to claim 4, wherein said surface of said intermediate section of the flange member is dimensioned to remove debris therefrom, said intermediate surface section substantially parallel to said shank.

7. A milling tooth according to claim 1, wherein said shank comprises a predetermined dimension for retaining to a rotatable drum therein, thereon or both thereof.

8. A milling tooth according to claim 1, wherein the concave surface of the flange member has a predetermined radius.

9. A milling tooth according to claim 1, wherein the concave surface of the flange member has a radius of from about 1.25 inches to about 1.437 inches.

10. A milling tooth according to claims 1, wherein said tooth is forged from a durable strong material.

11. A milling tooth according to claim 10, wherein said material is steel.

12. A milling tooth according to claim 10, wherein said material is hardened to a predetermined temperature.

13. A milling tooth according to claim 12, wherein said material is hardened to a temperature of 55° C.

14. A milling tooth for a comminution machine comprising: a shank for attachment to a drum of a mulching machine, a flange member disposed on an end of the shank, said flange member opposite a side connected to the shank, said flange member having a predetermined dimension for comminuting work thereof.

15. A method for comminuting work comprising the steps of: attaching a shank of a milling tooth to a drum of a mulching head of a comminution machine, rotating said drum, and directing a flange member disposed on an end of said shank at said work for comminution thereof, said flange member having a predetermined dimension for comminuting said work and removing debris therefrom.

16. A method according to claim 15, wherein said flange member is of a circular dimension for addressing said work.

17. A method according to claim 15, wherein a surface of the circular flange member is concave for ameliorating comminution of said work.

18. A method according to claim 15, wherein the concave surface of the flange member has a radius of from about 1.25 inches to about 1.437 inches.

19. A method according to claim 15, wherein said concave surface defines an angled circumference directed away therefrom to an intermediate section of said flange member said intermediate section of a predetermined dimension substantially angled away from said circumference for removing debris of said work away therefrom.

20. A method according to claim 15, wherein said intermediate section is dimensioned to be substantially parallel to said shank for removing debris of said work therefrom.
